(19) United States
(12) Patent Application Publication
(10) Pub. No.: US 2004/0151279 A1
(43) Pub. Date: Aug. 5, 2004

(54) Display and control element for an X-ray unit

(76) Inventors: Werner Beck, Ruckersdorf (DE); Brigitta Lobenhofer, Neunkirchen a. Brand (DE); Franz Meissner, Bamberg (DE); Axel Platz, Munchen (DE)

Correspondence Address: SCHIFF HARDIN & WAITE, Patent Department, 6600 Sears Tower, 233 South Wacker Drive, Chicago, IL, 60606, US

(21) Appl. No.: 10/725,293

(22) Filed: Dec. 1, 2003

Related U.S. Application Data
(60) Provisional application No. 60/430,035, filed on Nov. 29, 2002.

(30) Foreign Application Priority Data
Nov. 29, 2002 (DE) 10255955.4

(51) Int. Cl. H05G 1/54

(52) U.S. Cl. 378/117; 378/98

(57) ABSTRACT

The invention relates to a display and a control element for a control device for an X-ray unit. The triggering of an X-ray shot can be blocked automatically upon reaching a thermal loading limit for an X-ray source, where the display can display a period of time which the X-ray source requires in order to leave the thermal loading limit again. The triggering of an X-ray can be unblocked by operating the control element despite the thermal loading limit having been reached. In line with the invention, the display and the control element are integrated in a common break-time key.

### CROSS-REFERENCES TO RELATED APPLICATIONS

This application claims the benefit of U.S. Provisional Application No. 60/430,035, filed Nov. 29, 2002. This application is also related to U.S. Provisional Application Nos. 60/430,038 and 60/430,034, both also filed Nov. 29, 2002. All of these applications are herein incorporated by reference.

### BACKGROUND OF THE INVENTION

The invention relates to a display and a control element for an X-ray unit.

In clinical work environments, rational working methods and a high degree of automation are demanded in order to allow efficient and economic working. Rationalization in radiological departments have reduced the break intervals between X-ray shots to such a great extent that the time required for an X-ray tube which is in operation to cool down is often no longer achieved in the break intervals. Furthermore, peak traffic operation occurring in emergency diagnostics can also occasionally result in the break intervals being shortened to a critical degree in no time.

The anode plate in an X-ray tube is particularly susceptible to destruction as a result of overheating. The temperature of the anode plate can be monitored by measurement, or its thermal loading can be simulated in a tube load computer using a computation model. Limit values for the thermal loading are prescribed by the manufacturer according to the tube type. When a thermal loading limit is reached, whether it be as a result of this limit being exceeded or as a result of the immediate imminence of this limit being exceeded, which could result in the X-ray tube or the anode plate being damaged, the X-ray unit automatically prevents or blocks the triggering of an X-ray shot until the necessary cooling time has passed. In addition, a display or a warning signal informs the operator that the thermal loading limit has been reached.

When the reaching of a thermal loading limit is signaled, it is, however, possible to force further X-ray shots even though they are blocked, in principle, by the X-ray unit. This can be provided for medical reasons, for example. To this end, it is known practice to provide a separate key which an operator needs to operate in order to release the X-ray unit's blocking mechanism. It is then possible to use the normal shoot key to trigger an X-ray shot as normal. The need for a separate key to be operated is intended to ensure that the operator is aware under all circumstances that when forcing the X-ray shot there is the risk of damage to the X-ray tube or to the anode plate.

To inform the operator about the loading state of an X-ray tube, German Patent Document DE 100 39 416 A1 discloses a display which an X-ray unit, upon reaching a loading limit, uses to display the remaining cooling time which needs to pass in order for the X-ray tube to cool down sufficiently. An operator can use this time display to optimize his working sequence, for example. In addition, particularly in hurried cases, e.g. in emergency diagnostics, there can be a better estimation of whether the necessary cooling time is acceptable. On the basis of this, the operator can better decide whether X-ray shots need to be forced despite the loading limit having been reached.

A drawback of the known display and control elements is that the operator needs to direct his attention to two different elements of the X-ray unit in order to force X-ray shots. To detect the remaining cooling time after the loading limit has been reached, the operator needs to look at the cooling-time display. To release the X-ray unit's blocking mechanism, he needs to look at the separate, detached key for unblocking. When the unblocking key has been operated, an X-ray shot can be triggered by operating the shoot key, as a third element needing to be visualized.

Particularly with regard to X-ray units' displays, which are becoming ever more comprehensive and full of information, the need to devote attention to a plurality of separate elements for one and the same procedure is confusing, complicated and takes up an unnecessary amount of time. When working under a high level of strain and with a high level of time pressure, for example, in emergency medicine, this can easily result in the information on the cooling-time display no longer being viewed at all. Instead, an operator under the stress of a medical emergency situation will readily operate the separate unblocking key immediately upon reaching the loading limit, without purposefully also paying attention to the cooling-time display beforehand.

### SUMMARY OF THE INVENTION

It is the object of the invention to provide an X-ray unit having a cooling-time display and having an unblocking key for the purpose of forcing X-ray shots despite a thermal loading limit having been reached, in which the unblocking key and the cooling-time display can be detected and operated quickly and intuitively.

This object is achieved by an X-ray unit comprising an X-ray source whose triggering for an X-ray shot can be blocked automatically upon reaching a thermal loading limit for the X-ray source; a control device configured for controlling the X-ray source; a control element configured to initiate, when operated, an unblocking of the X-ray source when it is blocked; and a display connected to the X-ray unit configured to display an indication related to a period of time that the X-ray source requires in order to leave the thermal loading limit once the thermal loading limit has been reached; wherein the display and the control element are integrated in a common break-time key.

This object is also achieved by the break-time key itself for providing an indication related to a period of time that an X-ray source of an X-ray unit requires in order to leave a thermal loading limit once a thermal loading limit for an X-ray source has been reached, the break-time key being an integrated unit comprising: a display configured to display the indication; and a control element configured to initiate, when operated, an unblocking of the X-ray source when it is blocked due to reaching a thermal loading limit.

A basic idea behind the invention involves combining the cooling-time display and the unblocking key for forcing X-ray shots with one another and linking them to form a single, common break-time key. The break-time key as a combined key and display element can advantageously be detected at one glance and hence quickly. In addition, the combination results in elements with associated content also being brought together visually, which makes operating the X-ray unit more intuitive and ergonomic.

In one advantageous refinement of the invention, the break-time key is used not just for displaying the remaining cooling time and for unblocking the next X-ray shot but also permits immediate triggering of the next X-ray shot in addition to the unblocking. This makes the detection and operation of a further, additional control element unnecessary and saves a further control step. At the same time, the display functionality continues to ensure that it is clear to an operator that by triggering the X-ray shot there is a risk of damage or destruction.

### DESCRIPTION OF THE DRAWINGS

Exemplary embodiments of the invention are described in more detail below with reference to schematic figures.

FIG. 1 is a schematic block diagram showing an X-ray unit with a break-time key in line with the invention;

FIG. 2 is a pictorial representation showing a break-time key in which the period of time is displayed in units of time;

FIG. 3 is a pictorial representation showing a break-time key which displays the period of time as a percentage;

FIG. 4 is a pictorial representation showing a break-time key which displays the period of time symbolically; and

FIG. 5 is a pictorial representation showing a control device with a break-time key.

### DETAILED DESCRIPTION OF THE PREFERRED EMBODIMENTS

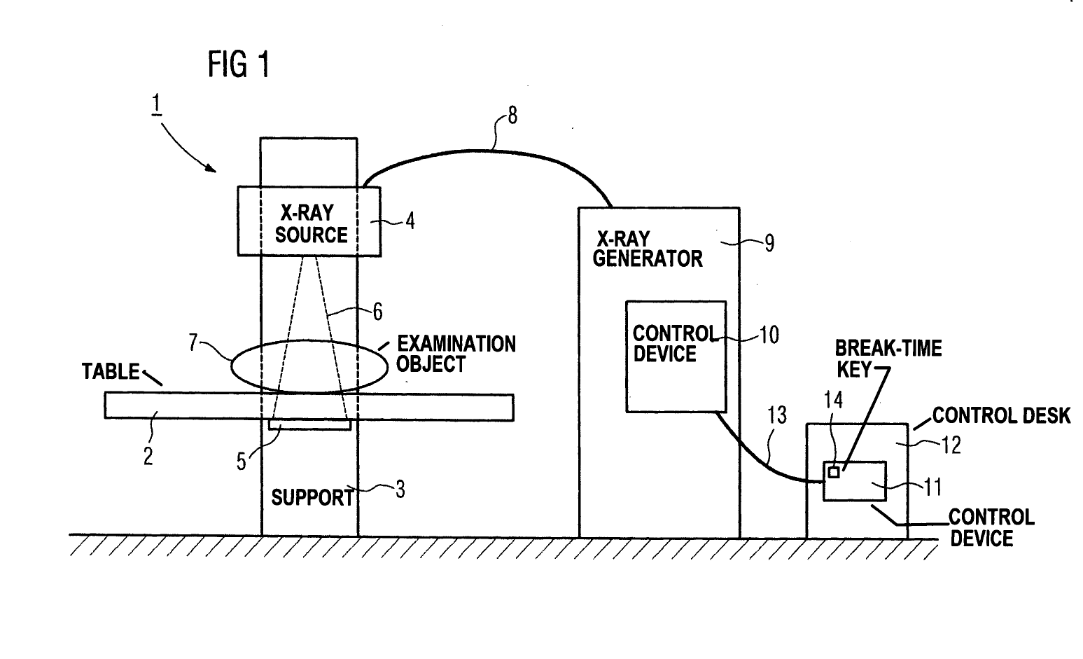

FIG. 1 schematically shows an X-ray unit 1 which, in the case of the present exemplary embodiment, comprises a patient table 2 (shown only schematically), which is supported by a mounting apparatus (not shown in FIG. 1), and a support apparatus 3 carrying an X-ray source 4. An X-ray image cassette 5 arranged on the patient table 2 is used for obtaining an X-ray image using an X-ray beam 6 which is emitted by the X-ray source 4 and is attenuated upon passing through an examination object 7 (shown only schematically), the marginal rays of the X-ray beam 6 being shown as dashes in FIG. 1.

In addition, an X-ray tube (not shown in FIG. 1) in the X-ray source 4 is connected to an X-ray generator 9 by way of an electric line 8. A control device 10 arranged in the housing of the X-ray generator 9 uses a computer program to control the X-ray generator 9 during the X-ray shot such that the operational values input using a control device 11 prior to the X-ray shot provide a tube voltage and a quantity of electricity. The control device 11 is arranged on a control desk 12 and is connected to the control device 10 by way of an electric line 13. The control device 10 prevents or blocks the triggering of X-ray shorts upon reaching a thermal loading limit, whether as a result of an X-ray tube's or anode plate's loading limit being exceeded or as a result of the exceeding thereof being immediately imminent. It is possible to ascertain that the loading limit has been reached by measuring the temperature of the anode or by recording the quantity of electricity which has flowed through the X-ray tube for each time, for example.

The X-ray unit 1 comprises an inventive break-time key 14 which is arranged on the control desk 12. The break-time key 14 incorporates a display of the period of time which the X-ray tube in the X-ray source 4 of the X-ray unit 1 needs, having reached a loading limit on account of the thermal loading of previous X-ray shots, to obtain a sufficient distance from the loading limit again. The break-time key 14 also incorporates a functionality as a key. To this end, it may alternatively be in the form of an element on a touch-sensitive screen (touch screen), in the form of an element on a non-touch-sensitive screen, or in the form of a mechanical key with additional display functionality, e.g. in the form of LEDs or LCDs. When the break-time key 14 is operated by pressing a key, the X-ray generator's block is lifted, which means that the triggering of X-ray shots can be forced despite the loading limit having been reached.

The period of time for cooling which is displayed by the integrated break-time key 14 can be ascertained, by way of example, using a computer (not shown in FIG. 1) in which cooling curves for an anode in the X-ray tube are stored and by measuring the temperature of the anode.

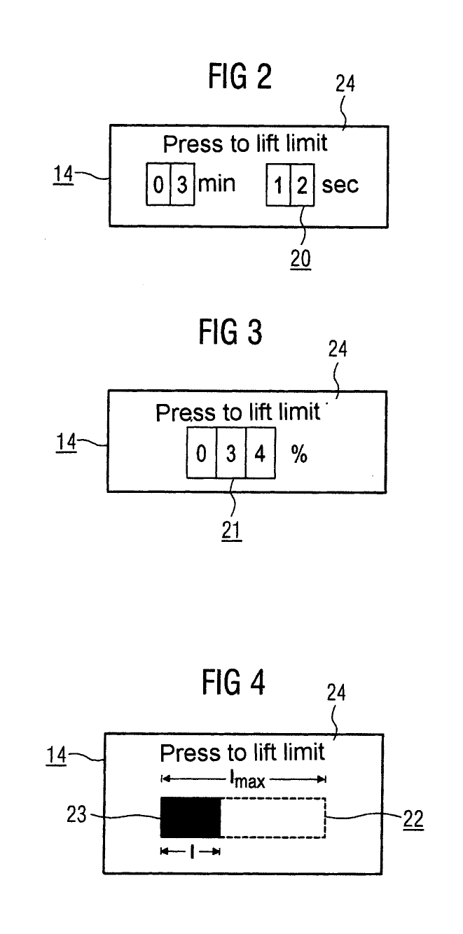

FIGS. 2 to 4 show options for the design of the cooling-time display for the break-time key 14 (which is not shown in detail in FIG. 1). In this case, it is of no matter whether the break-time key 14 is a touchscreen element or is in another form.

The display 20 incorporated in the break-time key 14 and shown schematically in FIG. 2 shows the period of time required for the X-ray tube to cool down in units of time, i.e., the period of time until the X-ray unit 1 shown in FIG. 1 is operational again. The period of time may be counted down in the manner of a countdown. In the case of the exemplary embodiment of the display 20 which is shown schematically in FIG. 2, the period of time which still remains until the X-ray tube is operational again may be shown in minutes and seconds. Alternatively, other units of time could be chosen. In addition, the break-time key 14 may display advice 24 (“Press to lift limit”) indicating that operating it allows the block on the next X-ray shot to be lifted.

In the case of the present illustrated exemplary embodiment, the X-ray tube still needs three minutes and twelve seconds until it is operational again. When the break-time key 14 has been operated, the period of time continues to be displayed.

FIG. 3 schematically shows a display 21 which is incorporated in the break-time key 14 and displays the period of time for the X-ray tube to cool down as a percentage. If the display 21 displays 100%, this can mean, by way of example, that the X-ray unit 1 has turned off at present on account of a risk of overheating. The percentage on the display 21 is thus a measure of the remaining period of time in relation to the total period of time of a cooling phase for the X-ray tube at present. In addition, the break-time key 14 may display, as indicated previously with respect to FIG. 2, advice 24 (“Press to lift limit”) indicating that operating the break-time key 14 allows the block on the next X-ray shot to be lifted.

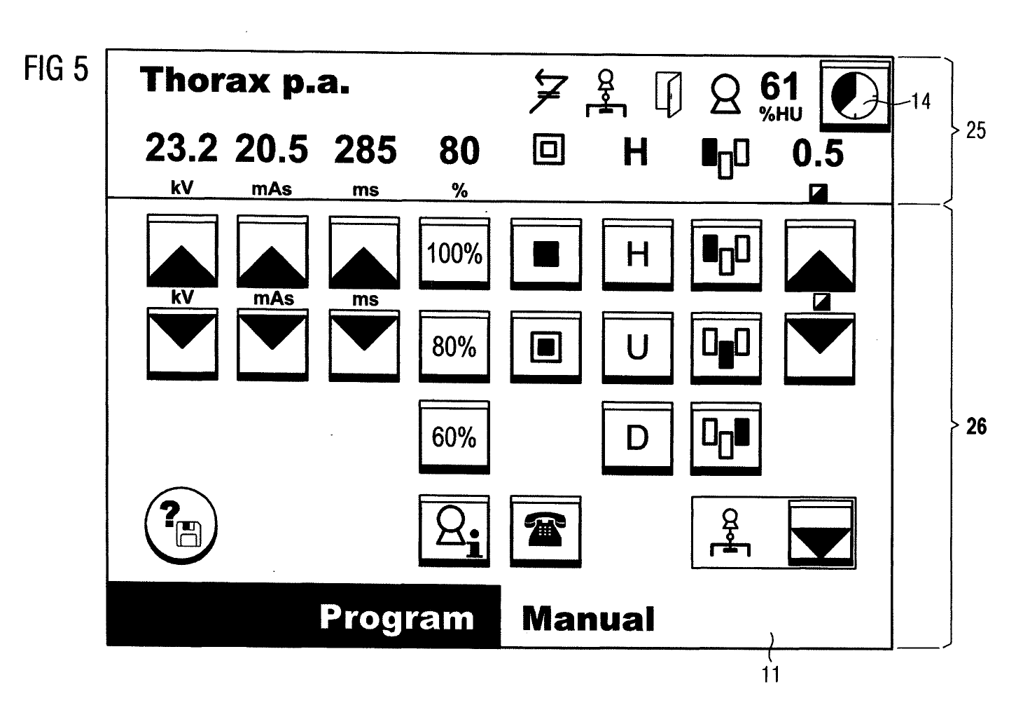

FIG. 4 schematically shows a display 22 which is incorporated in the break-time key 14 and displays the period of time for the X-ray tube to cool down symbolically. In the case of the present exemplary embodiment, the period of time is shown using a bar 23 whose length 1 is variable. When the bar 23 is at its maximum length lₘₐₓ, for example, this can mean, by way of example, that the X-ray unit 1 has turned off at present on account of a risk of overheating. The length l of the bar 23 is thus a measure of the remaining period of time in relation to the total period of time of the X-ray tube's cooling phase at present. In addition, the break-time key 14 may display, as indicated previously with respect to FIG. 2 and FIG. 3, advice 24 (“Press to lift limit”) indicating that operating the break-time key 14 allows the block on the next X-ray shot to be lifted.

Combinations of the displays 20-22 and 24 for the break-time key 14 which are shown in FIGS. 2 to 4 and are described are also possible. In addition, the break-time key 14 can also be switchable between the displays 20-22 and 24.

FIG. 5 shows a control device 11 in accordance with an embodiment of the invention, in this case in the form of a touchscreen. The control device 11 may display all the elements which can be used to select or set the operational values for the X-ray unit 1. It has an area in which an operational-value display 25 shows all the current settings and an area for inputting operational values 26, this area being able to be used by an operator to set all the operational values for the X-ray unit 1. Settings which an operator makes in the operational-value input 26 are immediately displayed in the operational-value display 25. The display and setting elements do not need any more detailed discussion in order to explain the invention.

The operational-value display 25 also contains a break-time key 14 in accordance with an embodiment of the invention. This is shown symbolically as a clock in FIG. 5. For display purposes, there are also other variants available, however, e.g. those explained previously in FIG. 2, FIG. 3 and FIG. 4. When the control device 10 establishes that a thermal loading limit for the X-ray tube has been reached or is immediately imminent, the break-time key 14 on the control device 11 is either revealed or is visually highlighted with clarity. The revelation or highlighting signals that the break-time key 14 has been activated and that a thermal loading limit has been reached. The break-time key 14 activated in this manner expediently has a design which makes it clearly discernible and conspicuous, e.g. through the use of a signal color or as a result of it flashing. It can also be in visually enhanced form as a prominent key. It is in a form such that an operator can immediately recognize it despite the extreme wealth of information on the control device 11.

By way of the symbolic display used in the form of a clock, the break-time key 14 shows the remaining period of time which is required in order for the X-ray tube to cool down after it has reached a thermal loading limit. When this cooling time has passed, the break-time key automatically returns to the visual background. If an X-ray shot needs to be taken before the cooling time has passed, however, then an operator needs to unblock this shot by operating the break-time key 14. The X-ray shot can then be triggered in the usual way by operating a shoot key (not shown in more detail). The separate activation and operation of the break-time key 14 ensure that an operator is clear about the risk of damage to the X-ray tube as a result of triggering an X-ray shot.

In one particular refinement of the invention, operating the break-time key 14 not only unblocks the next X-ray shot but also simultaneously triggers the X-ray shot. This saves one work step for an operator, since he does not first additionally need to visualize and operate the shoot key.

The integration of various display and control functionalities in the break-time key 14 thus increases the visual order of the control device 11 and makes it easier to operate.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Furthermore, the present invention could employ any number of conventional techniques for electronics configuration, signal processing and/or control, data processing and the like. The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An X-ray unit comprising:
an X-ray source whose triggering for an X-ray shot can be blocked automatically upon reaching a thermal loading limit for the X-ray source;
a control device configured for controlling the X-ray source;
a control element configured to initiate, when operated, an unblocking of the X-ray source when it is blocked; and
a display connected to the X-ray unit configured to display an indication related to a period of time that the X-ray source requires in order to leave the thermal loading limit once the thermal loading limit has been reached;
wherein
the display and the control element are integrated in a common break-time key.

2. The X-ray unit according to claim 1, wherein the indication is a countdown timer.

3. The X-ray unit according to claim 1, wherein the indication is a text-based percentage of total time indicator.

4. The X-ray unit according to claim 1, wherein the indication is a graphical display of the percentage of total time

5. A break-time key for providing an indication related to a period of time that an X-ray source of an X-ray unit requires in order to leave a thermal loading limit once a thermal loading limit for an X-ray source has been reached, the break-time key being an integrated unit comprising:
a display configured to display the indication; and
a control element configured to initiate, when operated, an unblocking of the X-ray source when it is blocked due to reaching a thermal loading limit.

6. The break-time key as claimed in claim 5, wherein the break-time key is in the form of an element on a touch-sensitive screen.

7. The break-time key as claimed in claim 5, wherein the break-time key is in a form of a key comprising integrated display chips.

8. The break-time key as claimed in claim 7, wherein the integrated display chips are selected from the group consisting of LCD chips and LED chips.
